(19) United States
(12) Patent Application Publication
(10) Pub. No.: US 2025/0355331 A1
(43) Pub. Date: Nov. 20, 2025

(54) TRANSPARENT DISPLAY

(71) Applicant: Carl Zeiss Jena GmbH, Jena (DE)

(72) Inventors: Xiang LU, Oberkochen (DE); Yi ZHONG-SCHIPP, Jena (DE); Viktor SCHÜTZ, Kahla (DE); Petr VOJTISEK, Jena (DE)

(73) Assignee: Carl Zeiss Jena GmbH, Jena (DE)

(21) Appl. No.: 18/872,697

(22) PCT Filed: Jun. 6, 2023
(86) PCT No.: PCT/EP2023/065135

§ 371 Date: Dec. 6, 2024

(30) Foreign Application Priority Data
Jun. 8, 2022 (DE) 10 2022 114 423.2

(51) Int. Cl. G03B 21/00; G02B 1/04; G02B 3/04; G02B 9/30; G02B 26/08; G03B 21/14; G03H 1/02; G03H 1/22

(52) U.S. Cl. CPC G03B 21/008; G02B 1/041; G02B 3/04; G02B 9/30; G02B 26/0833; G03B 21/147; G03H 1/0248; G03H 1/2205; G03H 2001/2215

(57) ABSTRACT

The invention relates to a transparent display comprising a holographic diffuser that extends substantially in a two-dimensional diffuser plane and comprising a projector, the projector having an image generation unit, in particular a digital micromirror device (DMD), and a reflection unit, wherein the reflection unit is configured to reflect, in the direction of the holographic diffuser, images generated by the image generation unit, and the image generation unit is arranged on a side of the diffuser plane lying opposite the reflection unit. The invention also relates to a method for producing a holographic diffuser.

### CROSS-REFERENCE TO RELATED APPLICATIONS

This application is a national stage application, filed under 35 U.S.C. § 371, of International Patent Application No. PCT/EP2023/065135, filed Jun. 6, 2023, which claims priority to DE 10 2022 114 423.2, filed Jun. 8, 2022, each of which is incorporated by reference herein in its entirety.

### FIELD OF THE INVENTION

Many fields of application require very large-format displays. Displays comprising a projector with an image generating unit and a screen are used for example in lecture or conference rooms. Short-distance projectors are increasingly being used, such as those disclosed in U.S. Pat. No. 10,067,324 B2 and WO 2018/117210 A1. In smaller rooms, a short-distance projector can also be arranged between the presenter and the screen so that the presenter can move freely in the room without getting in the way of the light beams traveling from the projector to the screen.

### BACKGROUND OF THE INVENTION

There is an increasing need for transparent displays. Transparent displays can provide a viewer with very immersive and augmented reality (AR) experiences. Transparent displays can be realized by means of transparent OLED displays embedded in glass substrates. The production of large transparent displays based on OLED displays is very costly. In addition, they are usually not sufficiently robust for use in harsher environments. Furthermore known are head-up displays in which images are projected onto transparent substrates, so that the images are reflected at the substrate and the viewer can visually perceive the images and simultaneously the environment which appears to be behind the substrate from their point of view. Head-up displays typically have a limited field of view, and the so-called eyebox, i.e. the volume in which the eyes of the viewer must be located in order to be able to perceive the projected images, is limited.

Proceeding from this, the present invention provides a cost-effective transparent display with a large field of view and a large eyebox.

### SUMMARY OF THE INVENTION

Proposed is a transparent display comprising a holographic diffuser which extends substantially in a two-dimensional diffuser plane, and comprising a projector, wherein the projector comprises an image generating unit, in particular a digital micromirror device (DMD), and a reflection unit, wherein the reflection unit is configured to reflect images generated by the image generating unit in the direction of the holographic diffuser, and wherein the image generating unit is arranged on a side of the diffuser plane that lies opposite the reflection unit.

A holographic diffuser can be understood to mean, in particular, an optical element which scatters incident light from one or more specific directions in a targeted manner such that it can be perceived by at least one viewer in an eyebox. By contrast, a conventional diffuser typically scatters light in many different directions and not in a specific direction in a targeted manner. The holographic diffuser can be configured such that the eyebox is situated at a predetermined angle and/or distance from the holographic diffuser. The holographic diffuser may be designed such that it scatters incident light of one or more predetermined wavelengths and/or wavelength ranges. The holographic diffuser can also be embodied such that the light is scattered in such a way that it can be viewed by viewers in more than two eyeboxes. For this purpose, a holographic diffuser may comprise a volume or surface hologram. A holographic diffuser may in particular comprise a holographic optical element.

In some exemplary embodiments, the diffuser may have a specific curvature, for example if it is applied to a curved carrier such as a curved glass pane. In such a case, the diffuser does not lie exactly in one plane. In such cases, diffuser plane is understood to mean a plane which approximates the shape of the diffuser, for example has the smallest deviation from the diffuser according to a specified metric. The metric can be, for example, a sum of absolute values of distances of the thus defined diffuser plane from the diffuser, a sum of square distances of the thus defined diffuser plane from the diffuser, or another function of distances of the thus defined diffuser plane from the diffuser. The distances can be measured in a specified grid, for example a square or rectangular grid.

Furthermore, a method for producing a holographic diffuser, in particular a holographic diffuser for a transparent display described above, is proposed, wherein with the use of one or more master tiles, different tile portions of a diffuser substrate are exposed, as a result of which a plurality of holographic diffuser tile portions are obtained, wherein the holographic diffuser tile portions form the holographic diffuser.

The proposed transparent display can be designed for reproducing images with very large dimensions, but at the same time have a particularly small depth. In particular, provision is made for the holographic diffuser and the optical elements of the projector to be adapted to one another such that a viewer perceives a very high-quality, evenly illuminated image.

### BRIEF DESCRIPTION OF THE DRAWINGS

Examples are described below with reference to the following figures, in which:

FIG. 1 shows a transparent display;

FIG. 2 shows part of a first projector of a transparent display; and

FIG. 3 shows part of a second projector of a transparent display.

### DETAILED DESCRIPTION OF THE INVENTION

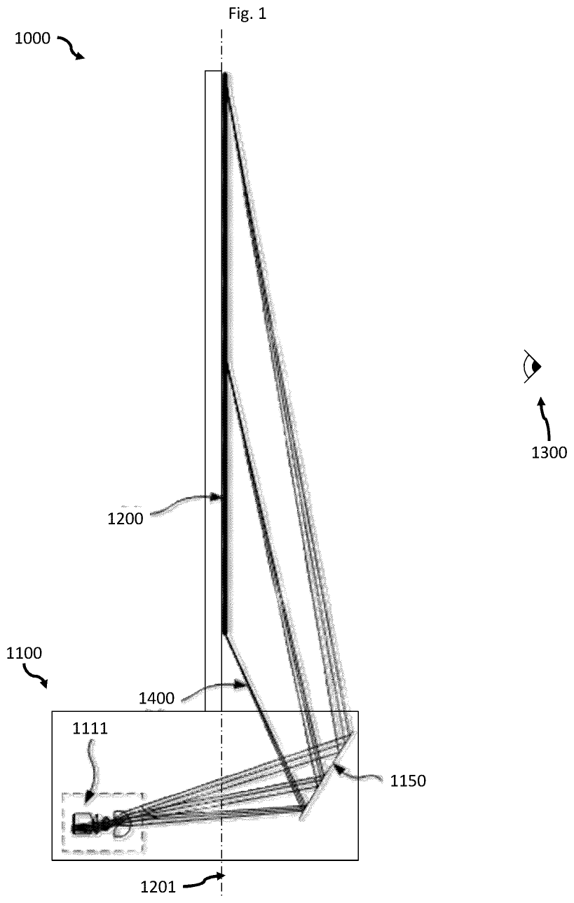

FIG. 1 illustrates a transparent display 1000. The transparent display 1000 comprises a holographic diffuser 1200 and a projector 1100. The holographic diffuser 1200 extends substantially in a two-dimensional diffuser plane 1201. The holographic diffuser 1200 and the projector 1100 are adapted to one another in such a way that a viewer 1300 can perceive not only objects on the side of the diffuser 1200 facing away from them, but also images generated by an image generating unit 1111. The image generating unit 1111 can be, in particular, a digital micromirror device (DMD).

The projector 1100 comprises a reflection unit 1150, which is configured to reflect images generated by the image generating unit 1111 in the direction of the holographic diffuser 1200. For this purpose, the image generating unit is arranged on a side of the diffuser plane 1201 that lies opposite the reflection unit.

In accordance with the embodiment illustrated in FIG. 1, the reflection unit 1150 can be arranged in particular on a side of the diffuser plane 1201 which is provided for a viewer 1300 to view the transparent display 1000. In particular, the reflection unit 1150 can be an aspheric mirror.

The transparent display 1000 may offer the viewer 1300 very immersive and AR experiences. In contrast to conventional transparent displays, transparent displays of the type illustrated in FIG. 1 can make very large eyeboxes and/or very large fields of view possible. At the same time, the transparent display 1000 can be of a very compact design. In particular, a depth of the transparent displays 1000 in a direction perpendicular to the diffuser plane 1201 may be significantly smaller than the dimensions of the transparent display 1000 in the diffuser plane 1021.

The transparent display 1000 may be a free-standing transparent display 1000. The transparent display 1000 can likewise be in the form of an integrated transparent display. In this way, functional surfaces can be provided. For example, the transparent display 1000 can be integrated into furniture, household appliances and/or entertainment devices. The transparent display 1000 can also be integrated in commercial devices, in particular machine tools. It is likewise conceivable to provide the transparent display as a display in a vehicle.

For example, the holographic diffuser 1200 can be mounted for this purpose on or in a window of the vehicle such as a windshield, a rear window or a side window, for example be arranged between two individual panes of a laminated glass window. Such windows typically have a specific curvature, which correspondingly leads to a curved shape of the diffuser 1200. In this case, as explained above, the diffuser plane 1201 is a plane which approximates the shape of the diffuser 1200. In the case of the side window, the projector 1100 may then be arranged, for example, in a B-pillar of the vehicle.

In arrangements for vehicle windows, the image generating unit 1111 or the reflection unit 1150 may lie disposed on an outside of the vehicle. In order to protect against mechanical influences (e.g. rain, airstream, particles), this unit can then be protected by an encapsulation, for example made of plastic, wherein the light can pass through transparent portions of the encapsulation and/or can be guided into the encapsulation and/or out of the encapsulation by way of an optical waveguide.

In the case of movable vehicle windows, as is often the case with side windows, the projector 1100 can be movable with the side window, for example in the abovementioned B-pillar or also below the side window. In this case, a projection can take place even if a side window is half-open, as long as the region of the vehicle window which has the diffuser 1200 is visible. In some exemplary embodiments, the reflection unit 1150 can also be adaptive, for example by tilting and/or a variable optical unit, so that the projection can follow a movement of the vehicle window. In other cases, the projector 1100 is fixedly installed. In such cases, for example, a projection can take place only when the side window is completely closed.

The holographic diffuser 1200 may in particular comprise a volume hologram. By embodying the holographic diffuser 1200 in the form of a volume hologram, it is possible to achieve a particularly small thickness of the diffuser 1200 compared with other diffusers 1200. By way of example, the use of a volume hologram may allow a thickness of the holographic diffuser 1200 of less than one millimeter, while a thickness of approximately 12 millimeters is typically required for Fresnel screens.

The provision of the transparent display 1000 in the form of a combination of the projector 1100 and the holographic diffuser 1200 can make it possible to provide a transparent display 1000 with a particularly high transparency for ambient light, with the result that a viewer 1300 can perceive the surroundings particularly well on the side of the holographic diffuser facing away from the viewer. The transparency can be more than 90%, for example. By providing the transparent display 1000 as a combination of holographic diffuser 1200 and projector 1100 with a correspondingly fixed relative position, the rays 1400 generated by the image generating unit 1111 and reflected by the reflection unit 1150 can be set in terms of their direction and wavelength in such a way that the very high sensitivity of a volume hologram to the angle of incidence and/or the wavelength of the incident rays 1400 can be optimally utilized.

Even though FIG. 1 shows a free-beam optical unit between the image generating unit 1111 and the reflection unit 1150 and between the reflection unit 1150 and the diffuser 1200, the light can also be guided at least partially by way of optical waveguides and/or inside a medium.

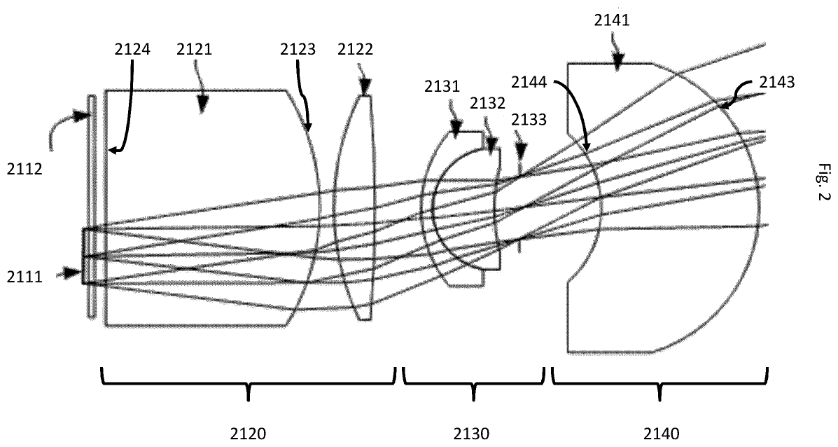

FIG. 2 shows part of a first projector which can be used as the projector 1100 of the transparent display 1000. The projector 1100 illustrated in FIG. 1 can in particular be a refraction unit. In the example shown in FIG. 2, the refraction unit may comprise a rear lens group 2120, a middle lens group 2130, and a front lens group 2140.

The refraction unit is arranged in the beam path between the image generating unit 1111 or 2111 and the reflection unit 1150. Here, the image generating unit 2111 is arranged off-center with respect to an optical axis of the refraction unit in an object plane. In this way, the area of the image generating unit 2111 can be utilized in the best possible manner in order to project the images generated by the image generating unit 2111 onto the holographic diffuser.

The image generating unit 2111 is a DMD. In principle, however, the use of other image generating units is also conceivable. A cover glass 2112 can be provided between the image generating unit 2111 and the refraction unit 2111.

The rear lens group is configured to couple light with an object-side telecentric beam path from the image generating unit 2111 into the refraction unit. In this way, a more uniform illumination of a holographic diffuser 1200 can be made possible compared with that which could be achieved with a projector according to WO 2018/117210 A1.

The rear lens group 2120 comprises an input-coupling block 2121. In an exemplary embodiment that is not illustrated, the input-coupling block can be configured as a total internal reflection prism. A total internal reflection prism can be understood to mean in particular an optical prism in which light is deflected by total internal reflection at an inner surface of the prism. In this case, in particular, the light can enter or exit the total internal reflection prism substantially perpendicularly. The input-coupling block 2121 shown in FIG. 2 has a convex surface 2123 facing away from the image generating unit 2111. The convex surface 2123 acts as a field lens in order to diffract the chief ray such that an object-side telecentricity is obtained.

The convex surface of the input-coupling block 2121 can also have the effect of reducing the numerical aperture of the object beam in this way. This can improve the input-coupling of the light from the image generating unit 2111, and so the brightness of the image reproduced by the holographic diffuser can be increased with the same light power output by the image generating unit 2111. In particular, this can imply a higher energy efficiency of the transparent display 1000. In particular, the object beam can have a numerical aperture (NA) of 0.2. The rear lens group 2120 has a first positive lens element 2122. The first positive lens element 2122 can serve to further collimate the beam. In particular, the first positive lens element 2122 can guide the beam to the middle lens group 2130 and the aperture stop 2133 thereof.

In particular, the middle lens group 2130 can be configured to correct chromatic aberrations. The middle lens group 2130 has a negative lens element 2131. In particular, the negative lens element 2131 can be produced from flint glass. Furthermore, the middle lens group 2130 comprises a second positive lens element 2132. In particular, the second positive lens element 2132 can be manufactured from crown glass. Proceeding from the image generating unit 2111, the second positive lens element 2132 is arranged in the beam path downstream of the negative lens element 2131. The negative lens element 2131 is in the form of a meniscus lens. This can enable the second positive lens element 2132 to be arranged very close to the negative lens element 2131. The second positive lens element 2132 and the negative lens element 2131 in combination act as a converging lens element. In this way, the light beam can be focused even more strongly before it passes through the aperture stop 2133 in order to achieve a strong magnification for imaging on the holographic diffuser that is as large as possible.

The front lens group 2140, which follows the aperture stop 2133, has a first aspheric surface 2143 and a second aspheric surface 2144 that is arranged upstream of the first aspheric surface 2143. The front lens group 2140 can have a low converging effect.

The first aspheric surface 2143 serves to correct field-dependent aberrations, in particular distortion and astigmatism. For this purpose, the first aspheric surface 2143 can be arranged in particular close to the reflection unit 1150.

The second aspheric surface 2144 is configured to correct aperture-dependent aberrations, in particular spherical aberrations. To this end, the second aspheric surface 2144 can be arranged in particular close to the aperture stop 2133.

In particular, the first front lens group 2140 can consist, as is shown in FIG. 2, of a single first aspheric lens element 2141, which has the first aspheric surface 2143 and the second aspheric surface 2144. The first aspheric lens element 2141 can be a meniscus lens. The first aspheric lens element 2141 can be manufactured in particular from polymethyl methacrylate (PMMA). This can enable particularly cost-effective production, in particular mass production by injection molding.

The first aspheric lens element 2141 may have a large thickness. As a result, an extremely great field curvature of a high order can be achieved. The high field curvature can allow the field curvature that is induced by the reflection unit 1150 to be compensated efficiently in order to obtain a planar image plane. This applies, in particular, if the reflection unit 1150 is an aspheric mirror. Consequently, it is possible to dispense with an intermediate image in the optical system, which can consequently have a simpler configuration.

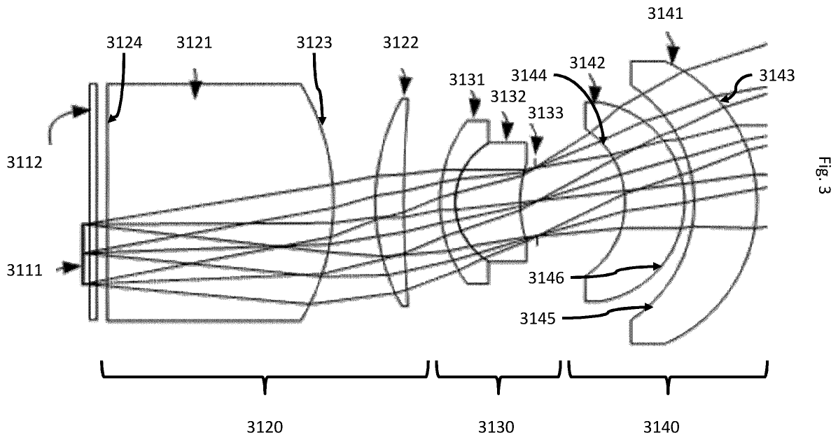

FIG. 3 shows part of a second projector of a transparent display. It likewise has an image generating unit 3111, a cover glass 3112, a rear lens group 3120, a middle lens group 3130, and a front lens group 3140. The input-coupling block 3121, the first positive lens element 3122, the negative lens element 3131, the second positive lens element 3132, the aperture stop 3133, the first aspheric surface 3143, and the second aspheric surface 3144 correspond to the input-coupling block 2121, the first positive lens element 2122, the negative lens element 2131, the second positive lens element 2132, the aperture stop 3133, the first aspheric surface 2143 and the second aspheric surface 2144, and so reference is made to the explanations relating to FIG. 2 in order to avoid repetitions with respect to the properties thereof.

In contrast to the part of the first projector illustrated in FIG. 2, the part of the second projector illustrated in FIG. 3 has a first aspheric lens element 3141 and additionally a second aspheric lens element 3142. The first aspheric lens element 3141 has the first aspheric surface 3143 and the second aspheric lens element 3142 has the second aspheric surface 3144. The division between the two aspheric lens elements 3141, 3142 can reduce the thermal load of the lens elements of the front lens group 3140. Moreover, by virtue of the division between two aspheric lens elements 3141, 3142, it is possible to provide two further aspheric surfaces 3145, 3146, which enable a further improved correction of higher-order field-dependent aberrations, in particular higher-order astigmatism and distortions.

As has been shown in FIG. 2, the refractive unit may consist of only five lens elements. As a result, the production outlay and the corresponding costs can be kept particularly low. The provision of two lens elements in the front lens group according to FIG. 3 can increase the quality of the reproduced image even further and increase the numerical aperture further. At the same time, the restriction to a total of six lens elements brings about substantial cost savings compared with conventional refractive units.

A transparent display according to FIG. 1 with a projector which has a refractive unit according to FIG. 2 or 3 can allow images to be reproduced on the holographic diffuser with a size of 1800 mm to 1050 mm at a resolution of 1920×1080 pixels (full HD 1080P).

The refractive units formed from the rear lens group 2120 or 3120, middle lens group 2130 or 3130, and front lens group 2140, 3140, as are illustrated in FIG. 2 or FIG. 3, can in particular be of a rotationally symmetric design, in particular eccentric free-form elements can be dispensed with. This can simplify the adjustment of the optical elements during production and greatly reduce the rejection rate during series production.

Despite the small dimensions and the simple construction of the projectors according to FIG. 2 and FIG. 3, the reflection unit can be arranged at a distance of only 15 cm from the holographic diffuser. Moreover, a throw ratio of less than 0.1, in particular of less than 0.08, can be achieved.

The variants according to FIG. 2 and FIG. 3 can in particular have the following properties:

| | FIG. 2 | FIG. 3 |
|---|---|---|
| Minimum value of the modulation transfer | 0.35 | 0.45 |
| function (MTF) at 0.43 line pairs per millimeter | | |
| Maximum distortion | −4.45% | −1.6% |
| Chief ray angle | <0.02° | <2.5° |
| Throw ratio | 0.08 | 0.1 |

A large holographic diffuser is required for a large-format transparent display. The production of such a large holographic diffuser is difficult since the exposure of large holograms is limited by the power of the light sources and the size of the manufacturing plants.

Proposed is therefore a method for producing a holographic diffuser, in particular a holographic diffuser for a transparent display described above, wherein with the use of a plurality of master tiles, different tile portions of a diffuser substrate are exposed, as a result of which a plurality of holographic diffuser tile portions are obtained, wherein the holographic diffuser tile portions form the holographic diffuser.

To produce large-format holographic diffusers, a plurality of smaller holographic diffusers are consequently joined together. The holographic diffuser is conceptually divided into a plurality of tiles, and these tiles are produced with at least one master tile. In the case of different designs for different diffuser tiles, it is also possible in each case to use separate master tiles for production. In series production, the individual diffuser tile portions are likewise produced separately. In this way, production difficulties can be reduced and the yield increased.

For generating the at least one master tile, use can be made of a point light source, which is arranged in a center of the aperture stop and is used to generate a construction beam with a free-form wavefront. In this way, it is possible to compensate for aperture-related aberrations.

In summary, the following examples are thus disclosed:
Example 1. A transparent display (1000),
   comprising a holographic diffuser (1200) which extends substantially in a two-dimensional diffuser plane (1201), and
   comprising a projector (1100),
   wherein the projector (1100) comprises
      an image generating unit (1111), in particular a digital micromirror device, DMD, and
      a reflection unit (1150),
   wherein the reflection unit (1150) is configured to reflect images generated by the image generating unit (1111) in the direction of the holographic diffuser (1200),
   wherein the image generating unit (1111) is arranged on a side of the diffuser plane (1201) that lies opposite the reflection unit (1150).
Example 2. The transparent display (1000) according to example 1,
   wherein the holographic diffuser (1200) comprises a volume hologram.
Example 3. The transparent display (1000) according to example 1 or 2,
   wherein the holographic diffuser (1200) has a thickness of less than one millimeter.
Example 4. The transparent display (1000) according to any of the examples 1 to 3,
   wherein the reflection unit (1150) is arranged on a side of the diffuser plane (1201) which is provided for a viewer (1300) to view the transparent display (1000).
Example 5. The transparent display (1000) according to any of the examples 1 to 4,
   wherein the projector comprises a refraction unit (2120, 2130, 2140; 3120, 3130, 3140),
   wherein the refraction unit (2120, 2130, 2140; 3120, 3130, 3140) is arranged in the beam path between the image generating unit (1111) and the reflection unit (1150).
Example 6. The transparent display (1000) according to example 5,
   wherein the image generating unit (1111; 2111; 3111) is arranged off-center with respect to an optical axis of the refraction unit (2120, 2130, 2140; 3120, 3130, 3140).
Example 7. The transparent display (1000) according to either of the examples 5 and 6,
   wherein the refraction unit (2120, 2130, 2140; 3120, 3130, 3140) comprises a rear lens group (2120; 3120),
   wherein the rear lens group (2120; 3120) is configured to couple light with an object-side telecentric beam path from the image generating unit (1111) into the refraction unit (2120, 2130, 2140; 3120, 3130, 3140).
Example 8. The transparent display (1000) according to example 7,
   wherein the rear lens group (2120; 3120) comprises an input-coupling block (2121; 3121) which has a convex surface (2123, 3123) facing away from the image generating unit (1111).
Example 9. The transparent display (1000) according to example 7 or 8,
   wherein the input-coupling block (2121; 3121) has a planar surface (2124; 3124).
Example 10. The transparent display (1000) according to any of the examples 7 to 9,
   wherein the input-coupling block is configured as a total internal reflection prism.
Example 11. The transparent display (1000) according to any of the examples 7 to 10,
   wherein the rear lens group (2120; 3120) has a first positive lens element (2122; 3122).
Example 12. The transparent display (1000) according to any of the examples 5 to 11,
   wherein the refraction unit (2120, 2130, 2140; 3120, 3130, 3140) comprises a middle lens group (2130, 3130), in particular a middle lens group arranged downstream of the rear lens group (2120; 3120) in the beam path proceeding from the image generating unit (1111),
   wherein the middle lens group (2130, 3130) is configured to correct chromatic aberrations.
Example 13. The transparent display (1000) according to example 12,
   wherein the middle lens group (2120; 3120) has a negative lens element (2131; 3131), in particular a negative lens element produced from flint glass.
Example 14. The transparent display (1000) according to example 13,
   wherein the negative lens element (2131) is a meniscus lens.
Example 15. The transparent display (1000) according to any of the examples 12 to 14,
   wherein the middle lens group (2130; 3130) has a second positive lens element (2132; 3132), in particular a second positive lens element which is produced from crown glass.
Example 16. The transparent display (1000) according to example 15,
   wherein the second positive lens element (2132; 3132) is arranged downstream of the negative lens element (2131; 3131) in the beam path proceeding from the image generating unit (1111; 2111; 3111).
Example 17. The transparent display (1000) according to any of the examples 12 to 16,
   wherein the middle lens group comprises a stop (2133), in particular a stop arranged downstream of the second positive lens element (2132) in the beam path proceeding from the image generating unit (1111).
Example 18. The transparent display (1000) according to any of the examples 5 to 17,
   wherein the refraction unit (2120, 2130, 2140; 3120, 3130, 3140) comprises a front lens group (2140; 3140), in particular a front lens group arranged downstream of the middle lens group (2120; 3120) in the beam path proceeding from the image generating unit (1111),
   wherein the front lens group (2120; 3120) has a first aspheric surface (2143; 3143) and a second aspheric surface (2144; 3144), in particular a second aspheric surface arranged upstream of the first aspheric surface (2143; 3143) in the beam path proceeding from the image generating unit (1111).
Example 19. The transparent display (1000) according to example 18,
   wherein the first aspheric surface (2143; 3143) is configured for correcting field-dependent aberrations.
Example 20. The transparent display (1000) according to example 18 or 19,
   wherein the second aspheric surface (2144; 3144) is configured for correcting aperture-dependent aberrations.
Example 21. The transparent display (1000) according to any of the examples 18 to 20,
   wherein the front lens group (2140; 3140) comprises a first aspheric lens element (2141; 3141),
   wherein the first aspheric lens element (2141; 3141) has the first aspheric surface (2143; 3143).
Example 22. The transparent display (1000) according to example 21,
   wherein the first aspheric lens element (2141) has the second aspheric surface (2144).
Example 23. The transparent display (1000) according to example 21,
   wherein the front lens group (3140) comprises a second aspheric lens element (3142), in particular a second aspheric lens element arranged upstream of the first aspheric lens element (3141) in the beam path proceeding from the image generating unit (1111),
   wherein the second aspheric lens element (3142) has the second aspheric surface (3143).
Example 24. The transparent display (1000) according to any of the examples 21 to 23,
   wherein the first aspheric lens element (2141; 3141) and/or the second aspheric lens element (3142) is manufactured from polymethyl methacrylate, PMMA.
Example 25. The transparent display (1000) according to any of the examples 21 to 24,
   wherein the first aspheric lens element (2141, 3141) and/or the second aspheric lens element (3142) is a meniscus lens.
Example 26. The transparent display (1000) according to any of the examples 1 to 25, wherein the holographic diffuser (1200) is arranged on or in a window of a vehicle.
Example 27. A method for producing a holographic diffuser, in particular a holographic diffuser for a transparent display (1000) according to any of the examples 1 to 26,
   wherein with the use of at least one master tile, different tile portions of a diffuser substrate are exposed, as a result of which a plurality of holographic diffuser tile portions are obtained,
   wherein the holographic diffuser tile portions form the holographic diffuser.
Example 28. The method for producing a holographic diffuser according to example 27,
   wherein, for generating the master tile, use is made of a point light source, which is arranged in a center of the stop and is used to generate a construction beam with a free-form wavefront.

1. A transparent display, comprising:
a holographic diffuser which extends substantially in a two-dimensional diffuser plane, and
comprising a projector, wherein the projector comprises an image generating unit, DMD, and
a reflection unit,
wherein the reflection unit is configured to reflect images generated by the image generating unit in the direction of the holographic diffuser, wherein the image generating unit is arranged on a side of the diffuser plane that lies opposite the reflection unit.

2. The transparent display as claimed in claim 1, wherein the holographic diffuser comprises a volume hologram.

3. The transparent display as claimed in claim 1, wherein the holographic diffuser has a thickness of less than one millimeter.

4. The transparent display as claimed in claim 1, wherein the reflection unit is arranged on a side of the diffuser plane which is provided for a viewer to view the transparent display.

5. The transparent display as claimed in claim 1, wherein the projector comprises a refraction unit arranged in the beam path between the image generating unit and the reflection unit.

6. The transparent display as claimed in claim 5, wherein the image generating unit is arranged off-center with respect to an optical axis of the refraction unit.

7. The transparent display as claimed in claim 5, wherein the refraction unit comprises a rear lens group configured to couple light with an object-side telecentric beam path from the image generating unit into the refraction unit.

8. The transparent display as claimed in claim 7, wherein the rear lens group comprises an input-coupling block which has a convex surface facing away from the image generating unit.

9. The transparent display as claimed in claim 7, wherein the input-coupling block has a planar surface.

10. The transparent display as claimed in claim 7, wherein the input-coupling block is configured as a total internal reflection prism.

11. The transparent display as claimed in claim 7, wherein the rear lens group has a first positive lens element.

12. The transparent display as claimed in claim 5, wherein the refraction unit comprises a middle lens group, wherein the middle lens group is configured to correct chromatic aberrations.

13. The transparent display as claimed in claim 12, wherein the middle lens group comprises a negative lens element.

14. The transparent display as claimed in claim 13, wherein the negative lens element is a meniscus lens.

15. The transparent display as claimed in claim 12, wherein the middle lens group comprises a second positive lens element.

16. The transparent display as claimed in claim 15, wherein the second positive lens element is arranged downstream of the negative lens element in the beam path proceeding from the image generating unit.

17. The transparent display as claimed in claim 12, wherein the middle lens group comprises a stop.

18. The transparent display as claimed in claim 5, wherein the refraction unit comprises a front lens group, wherein the front lens group has a first aspheric surface; and a second aspheric surface.

19. The transparent display as claimed in claim 18, wherein the first aspheric surface is configured for correcting field-dependent aberrations.

20. The transparent display as claimed in claim 18, wherein the second aspheric surface is configured for correcting aperture-dependent aberrations.

21. The transparent display as claimed in claim 18, wherein the front lens group comprises a first aspheric lens element, comprises the first aspheric surface.

22. The transparent display as claimed in claim 21, wherein the first aspheric lens element has the second aspheric surface.

23. The transparent display as claimed in claim 21, wherein the front lens group comprises a second aspheric lens element, wherein the second aspheric lens element has the second aspheric surface.

24. The transparent display as claimed in claim 21, wherein at least one of the first aspheric lens element or the second aspheric lens element is manufactured from polymethyl methacrylate, PMMA.

25. The transparent display as claimed in claim 21, wherein at least one of the first aspheric lens element or the second aspheric lens element is a meniscus lens.

26. The transparent display as claimed in claim 1, wherein the holographic diffuser is arranged on or in a window of a vehicle.

27. A method for producing a holographic diffuser as claimed in claim 1, comprising using at least one master tile to expose, different tile portions of a diffuser substrate are exposed to obtain, a plurality of holographic diffuser tile portions, wherein the holographic diffuser tile portions form the holographic diffuser.

28. The method for producing a holographic diffuser as claimed in claim 27, comprising generating the master tile using a point light source arranged in a center of the stop, the point light source generating a construction beam with a free-form wavefront.
